(19) United States
(12) Patent Application Publication
(10) Pub. No.: US 2004/0140380 A1
(43) Pub. Date: Jul. 22, 2004

(54) Device and method for pulverizing materials, especially glass

(76) Inventor: Johannes Vetter, Meerbusch (DE)

Correspondence Address: Connolly Bove, Lodge & Hutz, PO Box 2207, Wilmington, DE, 19899-2207, US

(21) Appl. No.: 10/467,590

(22) PCT Filed: Feb. 15, 2002
(86) PCT No.: PCT/EP02/01626

(30) Foreign Application Priority Data
Feb. 17, 2001 (DE) 101 07 553.7

(51) Int. Cl. B02C 19/12

(52) U.S. Cl. 241/23; 241/65

(57) ABSTRACT

The atomizing systems employed according to the state of the art in the production of powders are normally successively charged with liquid material from one or more melting pots for atomizing purposes. Due to the different ambient conditions that prevail inside the pot or in different pots during the melting or during the transfer of the melt, the resulting powder tends to be quite non-homogeneous. According to the invention, a device that serves to continuously melt a material is installed upstream from an atomizing system. A preferred example of such a device is the device known from WO 97/05440. The invention makes it possible to considerably improve the homogeneity of the powder produced by atomization. The system according to the invention allows not only the atomization of metallic material but also the production of non-metallic powder, especially glass powder.

The invention relates to a device as well as to a method for pulverizing materials.

Metal powders are commonly produced by means of the technique of gas or water atomization, among others (see, for example, H. W. Bergmann, G. Groβ, J. Vetter in the German publication titled gas aktuell, 36, page 4 [1988]). In this process, a jet of liquid metal is atomized by means of a gas or liquid jet that strikes it at a high velocity in an atomizing chamber. The fine melt droplets formed in this process rapidly solidify and accumulate in the form of small solid particles in the bottom area of the atomizing chamber. Gas atomization is carried out with air or inert gases such as nitrogen, argon or helium. In order to obtain particles having a defined size, the powder is subsequently sieved and/or filtered. Atomization employing a liquid as the atomizing medium is more advantageous than gas atomization because of the higher quenching speed of the atomized particles, as a result of which metallurgic deposition processes that occur during the cooling of the particles can be suppressed. Water atomization, however, entails the drawback that the formed particles then have to be separated from the water in a complex procedure and there is also the risk that the atomized metal might become contaminated by oxides. A particularly advantageous procedure is the atomization of molten metals with liquid nitrogen. For this purpose, liquid nitrogen at a pressure of 600 bar strikes a jet of liquid metal, thus atomizing it into minute droplets that immediately cool off and harden to form a powder. This technique allows the production of alloys made of highly oversaturated mixed crystals. In the prior-art atomization methods, the melt is fed via one or more melting pots which, after the material has melted, are each connected to the atomizing chamber, thus allowing the atomization of the material in batches.

A similar process employed for the production of a metal oxide powder is disclosed in EP 0,467,194 A1. Here, a jet of liquid metal is exposed to an oxygen stream at a high pressure ranging from 5 bar to 100 bar, as a result of which, on the one hand, the melt is atomized and, on the other hand, the metal is oxidized.

The prior-art methods have the disadvantage that the resulting powders are fairly non-homogeneous in terms of their size, shape and composition. This non-homogeneity is due, on the one hand, to the fact that the physical and chemical properties of the melts from different melting pots connected to the atomizing chamber differ to varying extents and the same applies to the properties of the melt of a single pot over the course of the melting operation. Moreover, the atomization of non-metallic melts, especially of glass, is either not possible at all or else it only yields unsatisfactory results since these substances solidify very quickly once they leave the smelting furnace. Consequently, such materials are usually pulverized in a very complex manner by means of mechanical treatment in the solid state. For instance, glass powder is manufactured by grinding glass fibers.

Therefore, the objective of the present invention is to create a device as well as a method for pulverizing materials with which the homogeneity of the formed powder is improved.

This objective is achieved by means of a device for pulverizing materials which has the features of Claim 1 as well as by a method for pulverizing materials which has the features of Claim 6.

According to the invention, a device for pulverizing materials having a melting unit and having an atomizer accommodated in an atomizing chamber uses an atomizing medium in order to atomize a molten material fed from the melting unit, whereby the melting unit has a smelting furnace that can be operated continuously. The continuous feed of the liquid material into the atomizing chamber markedly reduces the non-homogeneity encountered with the state of the art.

In a preferred embodiment of the device according to the invention, the smelting furnace of the melting unit has a melting aggregate that serves to melt the material and a combustion chamber that is physically separated from but thermally connected to the melting aggregate, whereby a predetermined temperature profile can be set along a lengthwise extension of the melting aggregate.

Such a smelting furnace is known from WO 97/05440. The device described there comprises a melting aggregate in the form of a vertically positioned tube that is provided with a gas-tight and fire-proof jacket. The material of which the jacket of the tube is made—normally ceramic material—is a function of the raw material to be melted and it is selected in such a way that reactions between the jacket material and the raw material to be melted are kept to a minimum. The upper end of the tube has an inlet opening through which the raw material is fed. An outlet opening that serves to discharge the melt is located in the lower section. The melting aggregate is concentrically accommodated in an insulated steel casing. The annular space formed between the insulation of the casing and the ceramic tube constitutes the combustion chamber, where the heat needed for the melting process is generated by burning a gas, preferably natural gas. Thus, the material to be melted is fired indirectly. The exhaust gases that are formed during the combustion process are carried off via an exhaust gas line that exits the combustion chamber, so that the gases do not come into contact with the melt or with the raw material. Consequently, the melt removed from the melting aggregate has a considerably lower fraction of inorganic impurities when compared to the melt of conventional tank melting processes, as a result of which the homogeneity of the formed powder is further improved.

Advantageously, the smelting furnace has an outlet opening that opens into the atomizing chamber for the molten material, said opening being provided with a heating element. Such a configuration prevents the melt from cooling off prior to the actual atomization, and it is also possible to atomize materials that solidify quickly, such as glass.

In a practical embodiment of the invention, the pressure and/or temperature of the atomizing medium fed to the atomizer can be adjusted. Varying the pressure results in different shapes of the particles formed while the temperature selection especially has an influence on the size of the particles.

A particularly advantageous atomizer has one or more nozzles that are directed at the liquid material—for example, in the form of a jet of liquid material—present in the atomizing chamber.

The objective of the invention is also achieved by means of a method for pulverizing materials which has the features of Claim 6.

In the method according to the invention for pulverizing materials, the material is melted in a melting unit so as to form a melt and subsequently the molten material is atomized when it is exposed to an atomizing medium, whereby the material is continuously fed to the melting unit, melted and conveyed to the atomizing chamber. In this manner, the powder formed achieves a greater homogeneity in comparison to methods according to the state of the art.

In a preferred embodiment, the viscosity and/or the temperature of the melt as it emerges from the smelting furnace are monitored continuously and/or at specified time intervals and then the temperature of the melt in the melting unit and/or the pressure or the temperature of the atomizing medium are adjusted as a function of the parameters measured.

In a refined embodiment, the material is placed into a melting aggregate of the melting unit during the melting procedure. A specified temperature profile is established along the lengthwise extension of the melting aggregate by means of the targeted addition of fuel and oxygen inside a combustion chamber that is associated with the melting aggregate, and this temperature profile creates the optimal conditions for the material or powder in question. The temperature profile can be flexibly and quickly changed and correspondingly adapted as a function of the requirements at hand.

The atomizing unit can be advantageously operated with a gas, a liquid and/or a liquefied gas. When gas is used, especially argon, nitrogen or helium are possibilities as—inert—atomizing media; water, for example, can be employed as a liquid atomizing medium. When liquefied gas is used as the atomizing medium, the use of liquid nitrogen is recommended since it stands out for its good cooling properties while concurrently being an inert gas.

It is particularly advantageous to use the device according to the invention and/or the method according to the invention for the production of glass powder. If the appropriate parameters are selected in the melting unit and/or in the atomizing unit, the atomization of glass can be employed to produce at least approximately spherical glass particles which are also very homogeneous in terms of their composition and size. Such glass particles are particularly advantageous for use, for instance, in reflective surfaces or paints.

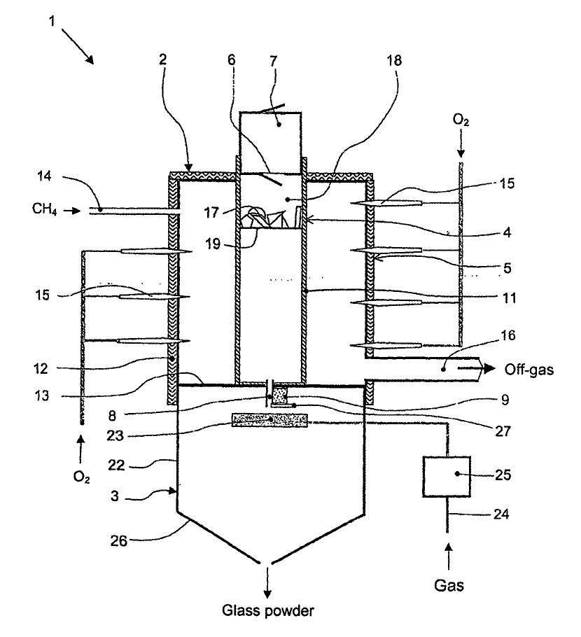

An embodiment of the invention will be illustrated in greater detail below with reference to the drawing. The single drawing (FIG. 1) schematically shows a cross section of the structure of a device according to the invention for pulverizing materials, especially glass.

The device 1 depicted in FIG. 1 has a smelting furnace 2 which serves to melt glass but which is also fundamentally suitable for melting other metallic or non-metallic materials, as well as an atomizing unit 3.

The smelting furnace 2 comprises an essentially tubular, vertically operated melting aggregate 4 that is concentrically accommodated in an essentially cylindrical combustion chamber 5. On its upper end, the melting aggregate 4 has an inlet opening 6 via which materials to be melted are fed. In order to ensure continuous operation of the smelting furnace 2, there is a lock arrangement 7 upstream from the inlet opening 6. New raw material 17 can be continuously fed in through the lock arrangement 7 without causing any lasting disturbance of the thermal or chemical conditions inside the melting aggregate 4 due to the penetration of outside air or the like.

On its lower section, the melting aggregate 4 has an outlet opening that serves to discharge the melt formed in the melting aggregate 4. On the outlet opening, there is an outlet nozzle 8 made of a material that conducts heat well and that is chemically inert such as, for instance, platinum, which is thermally connected to a heating element 9. The heating of the outlet nozzle 8 ensures that the material located inside the outlet nozzle 8 is present in a liquid state that is sufficient for the atomization that follows.

The wall 11 of the melting aggregate 4 consists of a heat-resistant and gas-tight material, for example, ceramic or metallic material. The material employed here is determined as a function of the type and composition of the substances to be melted; in particular, the material of the wall 11 should be such that, if at all possible, it does not react with the melt that has formed inside the melting aggregate 4.

The wall 13 of the combustion chamber 5 is provided with an insulating layer 12 at least on its cylindrical outer surfaces and on the exterior of its front end. A fuel feed line 14 for gaseous fuel, for instance, natural gas, as well as a plurality of injection nozzles 15 for oxygen pass through the wall 13. The injection nozzles 15 are arranged in a circular pattern at regular angular distances and in several rows at intervals one above the other. A gas exhaust line 16 is provided in order to carry off the off-gas formed during the combustion. The fuel fed in via the fuel feed line 14 is burned with the oxygen that is fed in via the injection nozzles 15. In this process, the quantity of oxygen fed in via the injection nozzles 15 in one a row can be set separately, whereby all in all, an oxygen amount that corresponds to the stoichiometric ratios is fed in. This approach makes it possible to set a temperature profile that is advantageous for the melting process throughout the melting aggregate 4.

The atomizing unit 3 has an atomizing chamber 22 inside of which there is an atomizer 23 fitted with several gas nozzles arranged concentrically around the longitudinal axis of the atomizing chamber 22. The gas nozzles are flow-connected via a feed line 24 to a gas supply source (not shown here). The temperature of the gas stream that flows through the feed line 24 can be regulated by means of a heating element 25. In the lower section of the atomizing unit 3, there is a collecting funnel 26 that is connected (in a manner not shown here) to a filter, to a sieve or to another means that serves to sort the solid particles that have been formed.

When the device 1 is in operation, a material is continuously fed into the melting aggregate 4 via the lock 7 in the form of raw material 17 and said raw material is melted by the heat generated in the combustion chamber 5, up to the height of a melting mirror 19. Ideally, the melting mirror is located at about two-thirds of the total height of the melting aggregate 4. Here, the headspace 18 defined by the space between the inlet opening 6 and the melting mirror 19 is partially or completely filled with raw material 17 that is in the process of being melted, in other words, it still contains solid constituents.

The molten material is fed to the atomizing unit 3 and it exits the outlet nozzle 8 in the form of a liquid stream of material that drops approximately along the longitudinal axis of the atomizing chamber 22. In the area of the atomizer 23, the stream of material is exposed to a gas stream flowing in through the concentrically arranged gas nozzles of the atomizer 23, as a result of which the stream of material is atomized into small liquid particles. Owing to the almost completely sealed off atomizing chamber 22, it is ensured that the atomizing process is largely shielded from outside influences. Particularly in the case of the atomization of metals, the use of an inert gas is additionally recommended.

The liquid particles, which gradually sink to the bottom over the further course, solidify and are then collected in the form of small solid particles by the collecting funnel 26. After the collecting funnel 26, the particles undergo a sorting process that is not of further interest and thus is not shown here, in order to yield particles of a uniform size. For purposes of ensuring that the material will still be in a sufficiently liquid state at the point in time of the atomization, it has proven to be advantageous to position the atomizer 23 in the direct vicinity of the outlet opening 8.

The viscosity and temperature of the melt emerging from the outlet opening 8 are continuously measured by means of a measuring device 27 so that, as a function of these parameters, both the temperature profile along the melting aggregate as well as the temperature and/or the pressure of the gas fed to the atomizer 23 are adjusted in order to obtain conditions that are ideal for the powder production. The temperature profile suitable for this purpose is ascertained empirically by means of a series of tests prior to the start-up of the production.

In contrast to powders, especially glass powders, manufactured by conventional, mechanical means, the particles produced according to the invention exhibit an essentially spherical shape.

### List of Reference Numerals

1 device

2 melting furnace

3 atomizing unit

4 melting aggregate

5 combustion chamber

6 inlet opening

7 lock arrangement

8 outlet opening

9 heating element

10 -

11 wall (of the melting aggregate)

12 insulating layer

13 wall (of the combustion chamber)

14 fuel feed line

15 injection nozzle

16 gas exhaust line

17 raw material

18 headroom

19 melting mirror

20 -

21 -

22 atomizing chamber

23 atomizer

24 feed line

25 heating element

26 collecting funnel

27 measuring device

1. A device for pulverizing materials, having a melting unit (2) and having an atomizer (23) accommodated in an atomizing chamber (22) uses an atomizing medium in order to atomize a molten material fed from the melting unit,
characterized in that
the melting unit has a smelting furnace (2) that can be operated continuously.

2. The device according to claim 1, characterized in that the smelting furnace (2) has a melting aggregate (4) that serves to melt the material and a combustion chamber (5) that is physically separated from but thermally connected to the melting aggregate.

3. The device according to claim 1 or 2, characterized in that the smelting furnace (2) has an outlet opening (8) that opens into the atomizing chamber (22), said opening being provided with a heating element (9).

4. The device according to one of the preceding claims, characterized in that the pressure and/or temperature of the atomizing medium fed to the atomizer (23) can be adjusted.

5. The device according to one of the preceding claims, characterized in that the atomizer (23) has one or more nozzles that are directed at the molten material present in the atomizing chamber.

6. A method for pulverizing materials in which the material is melted in a melting unit (2) so as to form a melt and subsequently the molten material is atomized when it is exposed to an atomizing medium,
characterized in that
the material is continuously fed to the melting unit (2), melted and conveyed to an atomizing unit (3) in order to be atomized.

7. The method according to claim 6, characterized in that the viscosity and/or the temperature of the melt as it emerges from the melting unit are monitored continuously and/or at specified time intervals and then the temperature of the melt in the melting unit (2) and/or the pressure or the temperature of the atomizing medium are adjusted as a function of the parameters measured.

8. The method according to claim 6 or 7, characterized in that, as it is melted, the material is received in the melting aggregate (4) of the melting unit (2) along whose lengthwise extension a predetermined temperature profile is set.

9. The method according to one of claims 6 to 8, characterized in that a gas, a liquid and/or a liquefied gas is employed as the atomizing medium.

10. A device according to one of claims 1 to 5 or a method according to one of claims 6 to 9, characterized by its use for the production of glass powder.
